(19) United States
(12) Patent Application Publication
(10) Pub. No.: US 2026/0219847 A1
(43) Pub. Date: Jul. 30, 2026

(54) CUSTOM TRACERS USING OSS JAVA AGENTS

(71) Applicant: Cisco Technology, Inc., San Jose, CA (US)

(72) Inventor: Walter Theodore HULICK, Jr., Pearland, TX (US)

(21) Appl. No.: 19/037,119

(22) Filed: Jan. 25, 2025

(51) Int. Cl. G06F 8/41

(52) U.S. Cl. CPC G06F 8/41

(57) ABSTRACT

In one embodiment, a process comprises: obtaining a class loader of a primary agent process by identifying a parent loader of an extension loader in which a custom agent extension operates; mapping shaded class names used by the primary agent process by inspecting a primary JAR file for classes required for the custom agent extension; creating a custom compilation JAR by renaming classdata files of the primary JAR file to class files and repackaging the class files into the custom compilation JAR; compiling the custom agent extension using the custom compilation JAR to reference the shaded class names; implementing a runtime class loading delegation mechanism, wherein the custom agent extension dynamically resolves required classes from the class loader of the primary agent process; and utilizing the shaded class names to create/register a custom tracer within the custom agent extension, wherein the custom tracer operates independently of the primary agent process.

### TECHNICAL FIELD

The present disclosure relates generally to computer networks, and, more particularly, to custom tracers using open source software (OSS) Java Agents.

### BACKGROUND

The Open Source Software (OSS) Java Agent is poised to become the de facto standard Java Agent for the Cloud Native environment as organizations transition from large, monolithic, hosted applications to cloud-based microservices architectures. This evolution places significant emphasis on the ability to develop and integrate value-added technologies into and around the OSS Java Agent.

To facilitate modifications or enhancements to the OSS Java Agent, the OpenTelemetry (OTEL) community introduced a mechanism known as “extensions.” These extensions, which are typically loaded with the OSS Java Agent, enable users to modify or expand agent functionality or even initiate other agents at runtime. While this approach provides flexibility for specific use cases, the capabilities of these extensions are limited.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example observability intelligence platform;

FIG. 4 illustrates an example of creation of a custom JAR;

FIG. 5 illustrates an example of pseudocode for delegation within a loadClass;

FIG. 6 illustrates an example of pseudocode for linking prefixes and loading names;

FIG. 7 illustrates an example of pseudocode for creation of a Custom Tracer; and

FIG. 8 illustrates an example procedure for custom tracers using open source software (OSS) Java Agents.

### DESCRIPTION OF EXAMPLE EMBODIMENTS

### Overview

According to one or more embodiments of the disclosure, custom tracers using open source software (OSS) Java Agents are provided. In particular, in one embodiment, an illustrative method herein may comprise: obtaining, by a process, a class loader of a primary agent process by identifying a parent loader of an extension loader in which a custom agent extension operates; mapping, by the process, shaded class names used by the primary agent process by inspecting a primary JAR file for classes required for the custom agent extension; creating, by the process, a custom compilation JAR by renaming classdata files of the primary JAR file to class files and repackaging the class files into the custom compilation JAR; compiling, by the process, the custom agent extension using the custom compilation JAR to reference the shaded class names; implementing, by the process, a runtime class loading delegation mechanism, wherein the custom agent extension dynamically resolves required classes from the class loader of the primary agent process; and utilizing, by the process, the shaded class names to create and register a custom tracer within the custom agent extension, wherein the custom tracer operates independently of the primary agent process and a primary tracer and exporter of the primary agent process.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

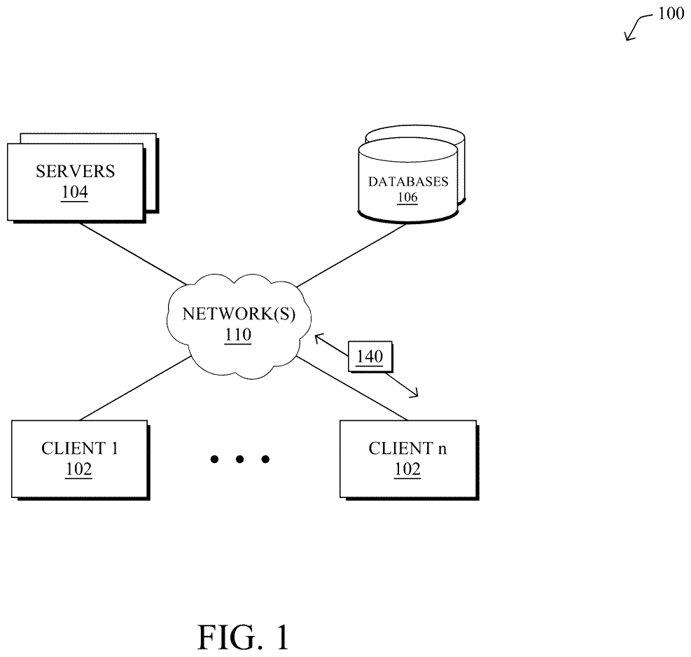

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

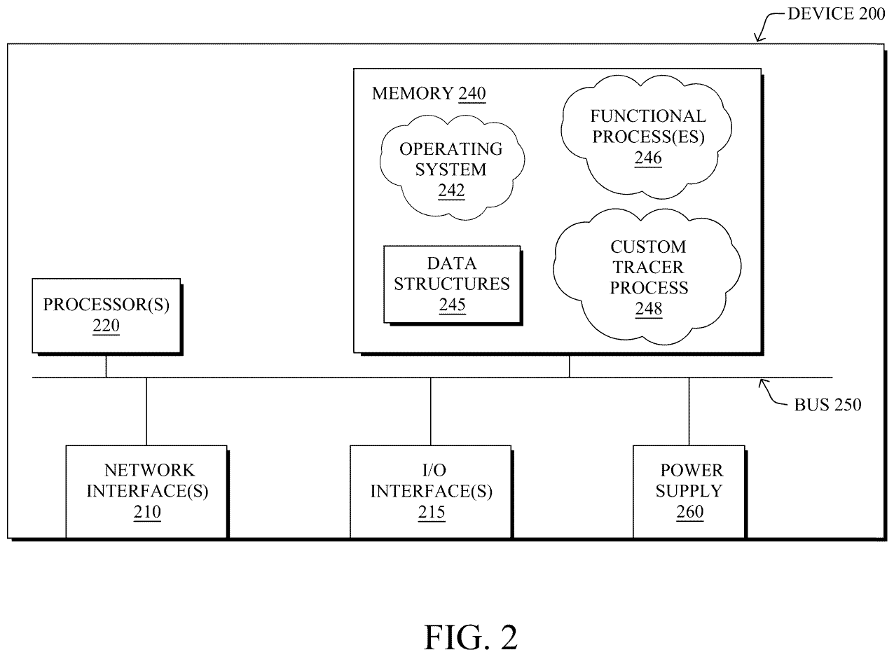

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, “custom tracer” process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Observability Intelligence Platform

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

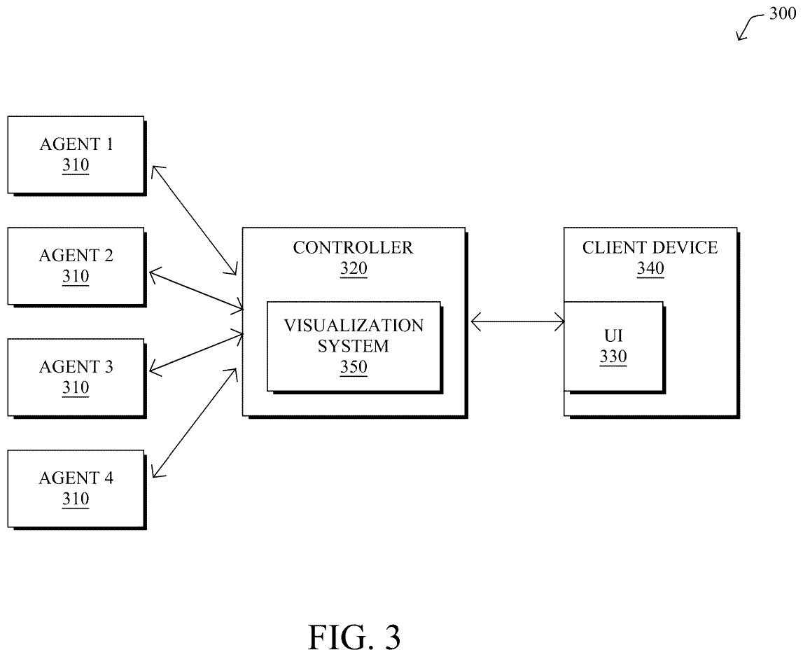

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users'(e.g., employees') devices (e.g., on their web browsers or otherwise). Other agents may specifically be based on categorical configurations of different agent operations, such as language agents (e.g., Java agents, . Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (agents 310) and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page —i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller instance may be installed locally and self-administered.

The controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain implementations, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Furthermore, for reference, the following discussion is a brief primer on OpenTelemetry:
An “OpenTelemetry Trace” is defined as one or more OpenTelemetry Spans with all Spans sharing a common trace ID.
An “OpenTelemetry Span” is reported from a monitored application by an OpenTelemetry SDK or auto-instrumentation agent and includes:
   A pointer to the “parent” span, the span that captures what happened immediately before this one;
   A set of attributes: Key/Value pairs with information about the running program;
   A status: to indicate whether the application hit an error while processing this part of the request;
   A span kind: helps describe what action this span captures (call entering/leaving a service, internal to the service, etc.);
   A set of resource attributes: Key/Value pairs with information about where the span came from;
   A name to summarize the operation the span represents; and
   A start and end time.

An OpenTelemetry system thus creates and/or ingests batches of spans from various sources (agents and collectors) into a backend system such as that described above. Notably, spans may be grouped by trace IDs into trace messages, and the trace messages may be processed, starting at the root, and following all parent-child links.

Each span in the traversal is evaluated as a potential starting point for a business transaction. (Note that business transactions can be nested.) In particular, evaluation criteria this can be based off of may be as follows:
Name;
The position of the span in the trace;
Span kind;
Resource attributes;
Span attributes;
Etc.

Furthermore, the rules that define conditions on these criteria can be defined by:
The system (“out of the box”/automatic rules);
Machine learning algorithms evaluating the ingested data;
A user (custom rules);
And so on.

Once any criteria is met, a Business Transaction (BT) Entity gets created. Metrics are then reported for the BT based on the status, start, and end time of the span that discovered it. All subsequent traversal of this trace will then report data in the “context” of this BT.

Those skilled in the art will appreciate that other configurations of observability intelligence may be used in accordance with certain aspects of the techniques herein, and that other types of agents, instrumentations, tests, controllers, and so on may be used to

collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### Custom Tracers Using OSS Java Agents

As noted above, the Open Source Software (OSS) Java Agent is positioned to become the leading Java Agent for Cloud Native environments as organizations increasingly shift from large, monolithic, hosted applications to distributed, cloud-based microservices architectures. This transition underscores the importance of enabling the development and integration of value-added technologies within and around the OSS Java Agent. As also noted, to support customization and enhancement of the OSS Java Agent, the OpenTelemetry (OTEL) community has implemented a system of “extensions.” These extensions, designed to be loaded alongside the OSS Java Agent, allow users to modify or expand its functionality and even deploy additional agents during runtime. While this mechanism offers flexibility for specific scenarios, the scope and capabilities of these extensions remain limited.

In particular, the existing extensions primarily focus on tweaking the processing of traces and spans generated by the agent's built-in instrumentation. However, the OSS Java Agent does not inherently support the addition or integration of independent tracers or exporters that operate outside the scope of its internal trace/span processing. This limitation restricts users who need to deploy additional tracing or exporting solutions alongside the OSS Java Agent.

Integrating another tracer or exporter currently requires the use of a separate Application Programming Interface (API) or Software Development Kit (SDK), resulting in significant complexity. This approach increases memory usage and introduces technical challenges due to the intricate class loading and “shading” mechanisms employed by the OSS Java Agent. These challenges create barriers to extending the agent's capabilities and hinder efficient integration of external tracing solutions.

The techniques herein, however, establish a mechanism to provide custom tracers using OSS Java Agents. In particular, the present disclosure provides a method to directly access the OSS Java Agent API/SDK, enabling seamless configuration of tracing components without introducing conflicts with the OSS Java Agent. This approach facilitates a highly optimized and tightly integrated solution for incorporating additional OpenTelemetry (OTEL) capabilities into the OSS Java Agent. By prioritizing minimal resource usage and simplicity, the techniques herein address limitations inherent in the current design of the OSS Java Agent, delivering functionality that is not currently, nor likely to be, supported by the broader community.

Specifically, according to one or more embodiments of the disclosure as described in detail below, an illustrative method herein may comprise: obtaining, by a process, a class loader of a primary agent process by identifying a parent loader of an extension loader in which a custom agent extension operates; mapping, by the process, shaded class names used by the primary agent process by inspecting a primary JAR file for classes required for the custom agent extension; creating, by the process, a custom compilation JAR by renaming classdata files of the primary JAR file to class files and repackaging the class files into the custom compilation JAR; compiling, by the process, the custom agent extension using the custom compilation JAR to reference the shaded class names; implementing, by the process, a runtime class loading delegation mechanism, wherein the custom agent extension dynamically resolves required classes from the class loader of the primary agent process; and utilizing, by the process, the shaded class names to create and register a custom tracer within the custom agent extension, wherein the custom tracer operates independently of the primary agent process and a primary tracer and exporter of the primary agent process.

As a reminder, OpenTelemetry (or “OTEL”) is a comprehensive framework designed to provide the tools, application programming interfaces (APIs), and/or software development kits (SDKs) necessary for instrumenting, generating, and/or exporting telemetry data (e.g., metrics, logs, and traces) that assist in analyzing the performance and behavior of a software system, as well as applications that are executed by the software system.

At its core, OpenTelemetry revolves around traces and spans. A trace represents a sequence of operations or events within a system, with spans serving as the fundamental building blocks of these traces (all spans of a trace share a common trace ID). Each span captures a single unit of work, including its operation name to summarize the operation the span represents, a unique identifier (span ID), a reference to its parent span (the span that captures what happened immediately before this one), and a variety of attributes such as key-value pairs (with information about the running program where the span originated), timestamps (start and end time), and resource metadata. Span may also contain a “status” to indicate whether the application hit an error while processing this part of the request, a “span kind” to helps describe what action this span captures (e.g., call entering/leaving a service, internal to the service, etc.), and so on.

These spans are typically created and reported by OpenTelemetry SDKs or auto-instrumentation agents embedded in applications. They flow through collectors and exporters to backend systems, where they are processed and visualized on dashboards, allowing developers to trace the lifecycle of requests and identify bottlenecks or errors.

To support these capabilities, OpenTelemetry provides SDKs (language-specific libraries) that allow developers to create spans, handle correlation headers, and export telemetry data to upstream collectors or backend endpoints. OpenTelemetry SDKs also expose an API for manipulating spans in code. Additionally, OpenTelemetry agents, which are language-specific binaries (binary modules) attached to running processes, enable auto-instrumentation by defining specific monitoring points within the code and leveraging SDK functionality at these points span operations.

Notably, an OpenTelemetry Collector serves as the central pipeline for this telemetry data (including spans), Receivers accept data from various sources (e.g., agents and SDKs), and Exporters send data out to various backends for analysis (e.g., to the Observability Intelligence Platform described above.

Among the tools developed by the OpenTelemetry community is the OSS Java Agent, a specialized Java agent designed to enable auto-instrumentation for applications using OpenTelemetry APIs and SDKs (SDK/API calls). Originally intended to bridge the gap in adoption by application developers and third party library developers to write directly to the SDK/API, the OSS Java Agent has evolved into a critical component for the Cloud Native ecosystem. That is, as noted above, as companies transition from monolithic hosted applications to cloud-based microservices, the design of the OSS Java Agent has allowed it to become the standard for Java-based auto-instrumentation.

The present disclosure, in particular, aims to address the scenario where a developer has an Agent Extension, and they want to monitor the communications between the OSS Java Agent and its associated Collector. However, the ultimate goal of the developer may be to direct this monitoring data to a separate receiver dedicated solely to this purpose, without making any changes to the configuration of the existing Collector, which is exclusively managed by the application team.

This presents two primary approaches, each with significant challenges. The first option involves incorporating an entirely standalone OTEL implementation, including the API and SDK. This would require adding around thirty additional JAR files, significantly increasing the OSS Agent's footprint. Moreover, this approach would necessitate overcoming the complexities of integrating new API and SDK components into the OSS Agent's class-loading and module-loading systems, as well as dealing with shading issues—challenges that likely explain why such functionality was not included in the first place.

The second option would be to leverage the OSS Agent's existing implementation and develop a custom Exporter that works within the agent's architecture. While this avoids the need for extensive additional libraries, it requires a deep, expert-level understanding of the OSS Agent's internal design to implement without causing disruptions or conflicts.

Notably, however, there are significant challenges associated with utilizing the OSS Java Agent API/SDK to create a standalone tracer. One primary obstacle lies in how the Agent Extension is “bootstrapped” into the OSS Java Agent Extension Loader, while many of the required classes are located in the OSS Java Agent General Loader. These classes are often “shaded,” meaning their names are non-standard from the OpenTelemetry SDK naming conventions to avoid conflicts with other implementations. That is, this shading process enables these classes to reside in the Boot Loader without conflicting with other components, but this also requires precise knowledge of their names in order to utilize them effectively. Additionally, the OSS Java Agent employs a “fat” JAR structure containing “shadowed” classes, some of which lack standard ‘.class’ extensions, using a ‘.classdata’ extension instead. These ‘.classdata’ files are uniquely handled by the OSS Java Agent Loader, which employs specialized mechanisms to load them. This unconventional structure effectively renders the JAR unsuitable for standard compilation processes, as the necessary classes cannot be resolved in their current form. The OSS Java Agent, in essence, employs non-standard class handling techniques, such as organizing these classes under an “inst” folder and modifying their extensions, making direct interaction with them highly complex.

Furthermore, the loader in which the Agent Extension operates does not delegate class loading responsibilities to the OSS Java Agent, as doing so would introduce class-loading conflicts between third-party libraries. Resolving these conflicts is non-trivial and requires careful architectural consideration.

Finally, implementing a custom exporter within the OSS Java Agent introduces additional complications. The OSS Java Agent would need to explicitly support the existence of such an exporter, requiring a global configuration system where the exporter is isolated and immune to the broader OSS Java Agent configuration.

As noted above, however, the techniques herein provide a novel solution to extend the OSS Java Agent by enabling the creation of isolated tracers and exporters that operate independently of the main agent's configurations. The approach as described in greater detail below leverages custom class loading delegation, the extraction and modification of the OSS Java Agent's JAR files for compilation purposes, and a specialized runtime mechanism that ensures seamless access to the OSS Java Agent's shaded classes.

Operationally, to enable an Agent Extension to access and extend the OSS Java Agent, the first step involves obtaining the OSS Java Agent Class Loader. The OSS Java Agent employs a general class loader, accessible via the parent of the Extension Loader where custom extensions are initialized. This relationship allows the required classes to be accessed programmatically.
code snippet: this.getClass( ).getClassloader( ).getParent( )

The next step involves locating and referencing the “Shaded” Class Names, needed for the custom tracer herein. The OSS Java Agent generally employs a consistent naming convention for shading its classes, such as by mostly always prefixing them with ‘io.opentelemetry.javaagent.shaded.’. Thus, by knowing the standard API names needed, inspecting the JAR file (jar tf opentelemetry-javaagent.jar|grep name) yields the following shaded class names:

```
//import io.opentelemetry.
  api.trace.propagation.W3CTraceContextPropagator;
import io.opentelemetry.
  javaagent.shaded.io.opentelemetry.api.trace.propagation.W3CTraceContextPropagator;
//import io.opentelemetry.context.propagation.ContextPropagators;
import io.opentelemetry.
  javaagent.shaded.io.opentelemetry.context.propagation.ContextPropagators;
//import io.opentelemetry.api.OpenTelemetry;
import io.opentelemetry.javaagent.shaded.io.opentelemetry.api.OpenTelemetry;
//import io.opentelemetry.api.trace.Tracer;
import io.opentelemetry.javaagent.shaded.io.opentelemetry.api.trace.Tracer;
//import io.opentelemetry.api.trace.SpanKind;
import io.opentelemetry.javaagent.shaded.io.opentelemetry.api.trace.SpanKind;
//import io.opentelemetry.api.trace.Span
import io.opentelemetry.javaagent.shaded.io.opentelemetry.api.trace.Span;
//import io.opentelemetry.context.Scope
import io.opentelemetry.javaagent.shaded.io.opentelemetry.context.Scope;
//import io.opentelemetry.semconv.resource.attributes.ResourceAttributes
import io.opentelemetry.javaagent.shaded.io.opentelemetry.semconv.ResourceAttributes;
//import io.opentelemetry.api.common.Attributes
import io.opentelemetry.javaagent.shaded.io.opentelemetry.api.common.Attributes;
```

Due to the OSS Java Agent's use of ‘.classdata’ files and its unconventional organization, direct compilation with the provided JAR file is impractical. To address this, a custom compilation JAR could be created by extracting, modifying, and restructuring the original OSS Java Agent JAR. This process includes renaming ‘.classdata’ files to ‘.class’ and relocating them within the directory structure (i.e., modifying the locations) to enable compatibility with standard compilation tools. (Note that while this would work for compilation, a real jar would need to be used for runtime.)

To do this by hand or manually, would be time consuming and error prone. As such, the following script was developed to be part of the build process:

rm -f opentelemetry-javaagent.jar rm -f -r zipFolder
#
# If already exist - just return
#
if [ -f opentelemetry-javaagent-compile.jar ]; then
echo “OSS Agent Jar to compile does exist...no need to build it...” exit 0
fi
#
# Get started - and download latest OSS Agent
#
echo “>>> Building the OSS Agent Jar to compile with - this only needs to be
done once” echo “ to upgrade versions - delete the opentelemetry-javaagent-
compile.jar and it” echo “ will rebuild a new one - this can take a few minutes...”
date
echo “>>> Getting OSS Agent jar”
curl -L https://github.com/open-telemetry/opentelemetry-java-instrumentation/
releases/download/v1.31.0/opentelemetry-javaagent.jar -o opentelemetry-
javaagent.jar
#
# Unzip it
#
echo “>>> Unzipping OSS Agent jar”
unzip -q opentelemetry-javaagent.jar -d zipFolder
#
# Copy inst folder (has the .classdata files) up a level even with real classes and
then remove original
#
echo “>>> Copying inst folder up one level” cp -r zipFolder/inst/* zipFolder
echo “>>> Removing inst folder” rm -r zipFolder/inst
#
# Rename all .classdata to .class
#
echo “>>> Renaming .classdata to .class (This can take a few minutes...)”
find . - depth -name “*.classdata” -exec sh -c ‘mv “$1” “${1%.classdata}.class”’_
{ } \;
#
# Zip up the jar we need to compile with
#
echo “>>> Creating new jar to compile with”
jar cf opentelemetry-javaagent-compile.jar -C zipFolder .
#
# Clean it up
#
echo “>>> Cleaning up...”
rm opentelemetry-javaagent.jar rm -r zipFolder
echo “>>> End Time” date

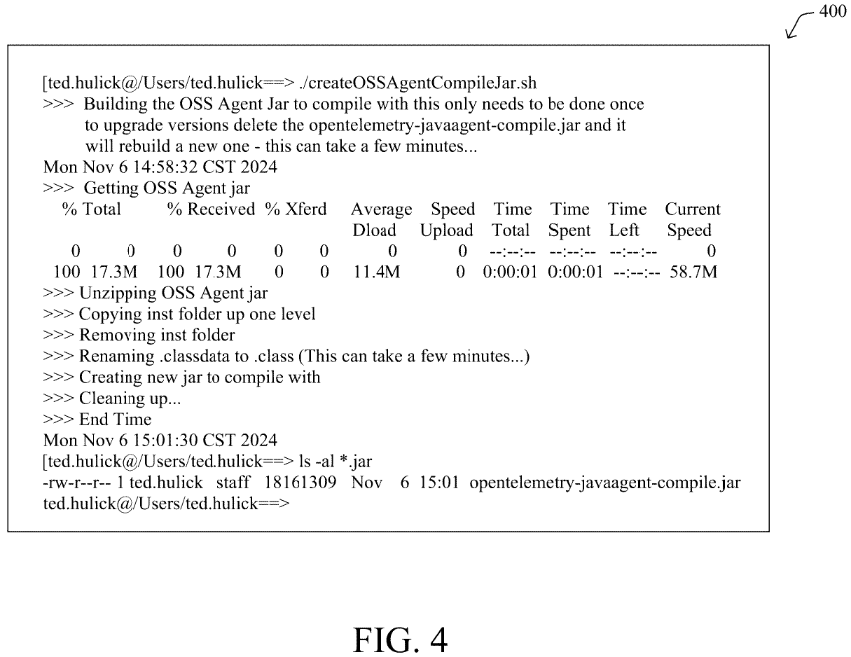

As an example, FIG. 4 illustrates an example output 400 of execution of the above script. At this point, the resulting custom JAR enables the compilation of Agent Extensions with access to *every* OSS Java Agent class for build purposes, while maintaining runtime compatibility with the original OSS Java Agent.

During runtime, the Agent Extension operates in an isolated class loader, distinct from the OSS Java Agent Class Loader. To facilitate interaction between these loaders, the techniques herein employ a delegation mechanism: the Agent Extension identifies required classes and delegates their loading to the OSS Java Agent Class Loader. The OSS Java Agent Class Loader then resolves and provides these classes, ensuring seamless integration:

In other words, regarding runtime loading/accessing the OSS Java Agent classes from the Agent Extension herein, the OSS Java Agent Classes are in the OSS Java Agent Class Loader (io.opentelemetry.javaagent.bootstrap.AgentClassLoader). The Agent Extension (in another isolated Class Loader—a new Agent Class Loader) that needed access to the code is not in the Agent Class Loader and the OSS Java Agent Class Loader is not a parent of the Agent Extension (and could not be without causing problems with library conflicts) so standard parent or loader chain delegation would not work between the two code systems.

The solution herein, therefore, is to use the “new” Agent Class Loader to identify classes that needed to be loaded from the OSS Java Agent Class Loader, and have that call into the OSS Java Agent Class Loader to pass the new code the “root classes” and when loaded it would then automatically load/delegate the other classes just as it normally would, under the premise that it's the OSS Java Agent that needed the classes actually “tricking” that loader.

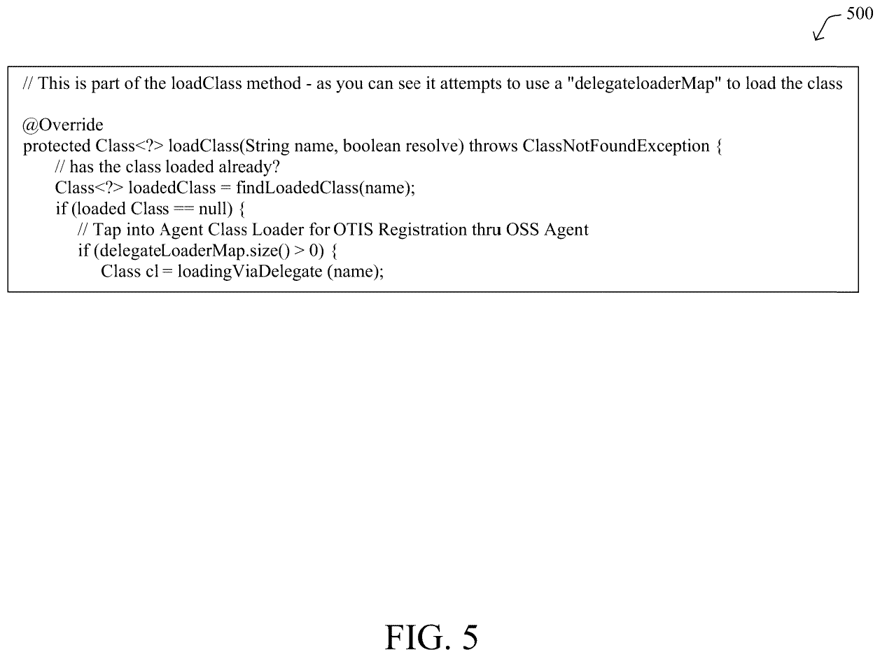

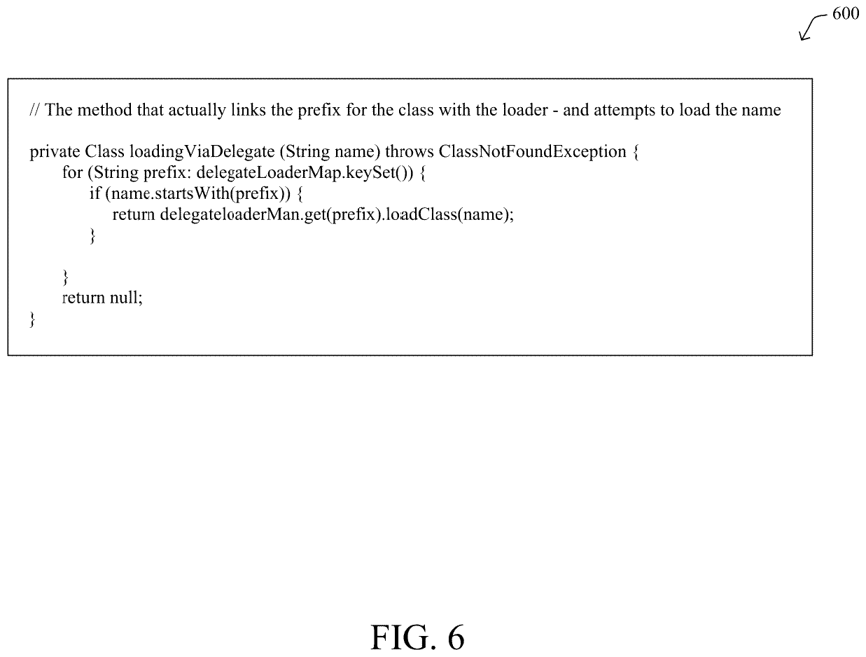

The “delegation” changes shown in FIG. 5 (example 500) and FIG. 6 (example 600) were then made to the new Agent Class Loader. The result is code doing a lookup to a delegateLoaderMap that contains a “prefix” to the class-in this case “io.opentelemetry” which points to the loader to delegate to-which is the “AgentClassLoader” instance from the OSS Java Agent. If found, its “loadClass(name)” method is called, which then returns the class to the new loader and the results are loading the classes as though they were classes that belonged to the new loader—even though they were not.

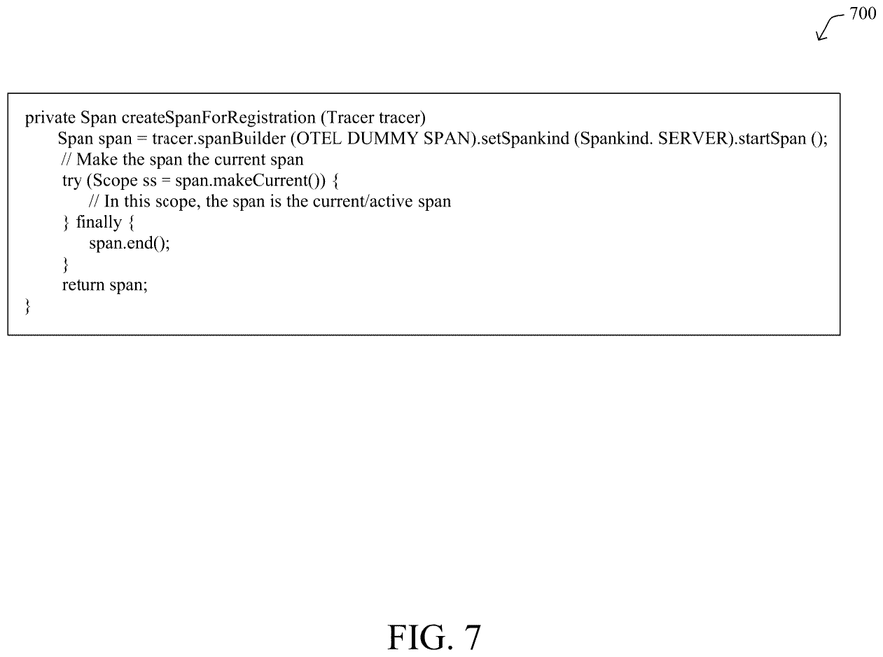

Regarding creation of the Custom Tracer, FIG. 7 illustrates an example 700 (e.g., a test Registration Tracer to a backend test receiver), where using the shaded classes, the techniques herein use the OSS Java Agent shaded classes to create the Trace/Spans that are isolated from the main OSS Java Agent configuration. This enables use cases such as sending traces to a specialized backend receiver without requiring reconfiguration of the application's primary Collector.

In closing, the OSS Java Agent can be extended to support “isolated” custom Tracers with Exporters for whatever functions that might be needed without interfering with the main Agent Tracer and Export configuration-as long as the Class Loading delegation and “tricks” in the Agent are recognized and compensated for-as well the ability to build a “compilation jar” that can be used in the build system for the Agent Extension. Even if the OSS Java Agent architecture is modified, the design of the techniques herein takes that into account and would handle refactoring around the “tricks” and other aspects and nuances of the OSS Java Agent.

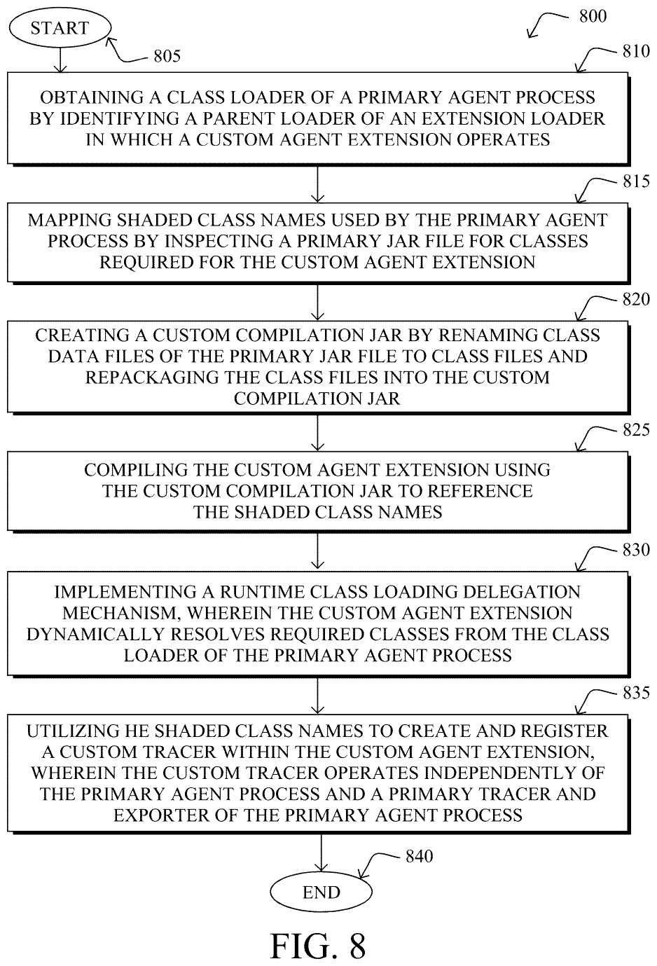

FIG. 8 illustrates an example simplified procedure for custom tracers using open source software (OSS) Java Agents in accordance with one or more embodiments described herein. For example, a non-generic, specifically configured device (e.g., device 200, an apparatus) may perform procedure 800 by executing stored instructions (e.g., process 248). The procedure 800 may start at step 805, and continues to step 810, where, as described in greater detail above, the techniques herein obtain a class loader of a primary agent process by identifying a parent loader of an extension loader in which a custom agent extension operates. In one embodiment, the primary agent process comprises an open source software (OSS) Java Agent. In one embodiment, obtaining the class loader of the primary agent process further comprises: invoking a method to retrieve the parent loader of the extension loader during runtime.

In step 815, the techniques herein map shaded class names used by the primary agent process by inspecting a primary JAR file for classes required for the custom agent extension. In one embodiment, mapping the shaded class names comprises: searching for class name prefixes matching a predetermined pattern associated with the primary agent process.

In step 820, the techniques herein create a custom compilation JAR by renaming classdata files of the primary JAR file to class files and repackaging the class files into the custom compilation JAR. In one embodiment, the techniques herein comprise implementing a script as part of a build process to automate creating the custom compilation JAR.

In step 825, the techniques herein may then compile the custom agent extension using the custom compilation JAR to reference the shaded class names.

In step 830, the techniques herein may then implement a runtime class loading delegation mechanism, wherein the custom agent extension dynamically resolves required classes from the class loader of the primary agent process. Note that in one embodiment, the runtime class loading delegation mechanism includes maintaining a mapping of class name prefixes to corresponding class loaders for dynamic resolution during execution. In one embodiment, too, the runtime class loading delegation mechanism resolves conflicts between third-party library dependencies by isolating a given class loaders of the custom agent extension from the class loader of the primary agent process.

Accordingly, in step 835, the techniques herein may now utilize the shaded class names to create and register a custom tracer within the custom agent extension, wherein the custom tracer operates independently of the primary agent process and a primary tracer and exporter of the primary agent process. In one embodiment, the custom agent extension uses the shaded class names to create spans with attributes, timestamps, and identifiers unique to the custom tracer. In one embodiment, the custom tracer transmits traces to a backend receiver dedicated to the custom agent extension without requiring reconfiguration of a collector of the primary agent process.

Procedure 800 may end at step 840.

It should be noted that while certain steps within the procedures above may be optional as described above, the steps shown in the procedures above are merely examples for illustration, and certain other steps may be included or excluded as desired (e.g., ensuring that the custom tracer is immune to modifications in global configuration settings of the primary agent process, dynamically adapting to changes in architecture of the primary agent process, including modifications to class naming conventions or class loader hierarchies, and so on). Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: obtaining a class loader of a primary agent process by identifying a parent loader of an extension loader in which a custom agent extension operates; mapping shaded class names used by the primary agent process by inspecting a primary JAR file for classes required for the custom agent extension; creating a custom compilation JAR by renaming classdata files of the primary JAR file to class files and repackaging the class files into the custom compilation JAR; compiling the custom agent extension using the custom compilation JAR to reference the shaded class names; implementing a runtime class loading delegation mechanism, wherein the custom agent extension dynamically resolves required classes from the class loader of the primary agent process; and utilizing the shaded class names to create and register a custom tracer within the custom agent extension, wherein the custom tracer operates independently of the primary agent process and a primary tracer and exporter of the primary agent process.

In still other implementations, a tangible, non-transitory, computer-readable medium storing program instructions that cause a device to execute a process comprising: obtaining a class loader of a primary agent process by identifying a parent loader of an extension loader in which a custom agent extension operates; mapping shaded class names used by the primary agent process by inspecting a primary JAR file for classes required for the custom agent extension; creating a custom compilation JAR by renaming classdata files of the primary JAR file to class files and repackaging the class files into the custom compilation JAR; compiling the custom agent extension using the custom compilation JAR to reference the shaded class names; implementing a runtime class loading delegation mechanism, wherein the custom agent extension dynamically resolves required classes from the class loader of the primary agent process; and utilizing the shaded class names to create and register a custom tracer within the custom agent extension, wherein the custom tracer operates independently of the primary agent process and a primary tracer and exporter of the primary agent process.

The techniques described herein, therefore, provide for custom tracers using open source software (OSS) Java Agents, representing a significant step forward in extending the OSS Java Agent's capabilities. By addressing architectural challenges and enabling isolated tracing and exporting functionality, the techniques herein allow for customization and optimization in Java-based cloud-native environments. Specifically, the present disclosure provides several key advantages:
Isolated Tracing: The techniques herein enable custom tracers and exporters to function independently of the main OSS Java Agent configuration.
Custom Compilation JAR: The techniques herein simplify the development process by creating a tailored JAR for extension compilation while preserving runtime compatibility.
Dynamic Class Loading: The techniques herein utilize delegation mechanisms to resolve shaded classes at runtime without causing conflicts.
Broad Applicability: While tailored to the OSS Java Agent, the techniques herein can be adapted to other agents with similar architecture.

There is currently no comparable solution in the industry that allows for such seamless and isolated integration with the OSS Java Agent. The techniques herein addresses critical limitations faced by developers and offer a scalable, efficient approach to extending the OSS Java Agent's functionality.

Illustratively, the techniques described herein may be performed by hardware, software, and/or firmware, (e.g., an “apparatus”) such as in accordance with the custom tracer process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

As used herein, the terms “application” and “applications” generally refer to a computer program or computer programs that are designed to carry out a specific task or tasks other than task(s) relating to the operation of the computer itself. In particular, an “application” can refer to a collection of executable computer code that is provided to, or is integrated into, a software system. As a result, the “application” or “applications” discussed herein can refer to any collection computer code that is executed by, or provided by, the software system.

By way of example, the applications mentioned herein can be host applications that run on various computing systems, such as a physical computer (e.g., a desktop, a laptop, a smartphone, a tablet, a phablet, etc.), a virtual computer (e.g., a thin client, a virtual machine, a Linux container, etc.), a data center (e.g., rack server, supercomputer, etc.), and/or a software defined data center (e.g., bare metal server), etc. Accordingly, the applications described herein can be locally provided host applications, virtually provided host applications, and so on and so forth.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
obtaining, by a process, a class loader of a primary agent process by identifying a parent loader of an extension loader in which a custom agent extension operates;
mapping, by the process, shaded class names used by the primary agent process by inspecting a primary JAR file for classes required for the custom agent extension;
creating, by the process, a custom compilation JAR by renaming classdata files of the primary JAR file to class files and repackaging the class files into the custom compilation JAR;
compiling, by the process, the custom agent extension using the custom compilation JAR to reference the shaded class names;
implementing, by the process, a runtime class loading delegation mechanism, wherein the custom agent extension dynamically resolves required classes from the class loader of the primary agent process; and
utilizing, by the process, the shaded class names to create and register a custom tracer within the custom agent extension, wherein the custom tracer operates independently of the primary agent process and a primary tracer and exporter of the primary agent process.

2. The method of claim 1, wherein obtaining the class loader of the primary agent process further comprises:
invoking a method to retrieve the parent loader of the extension loader during runtime.

3. The method of claim 1, wherein mapping the shaded class names comprises:
searching for class name prefixes matching a predetermined pattern associated with the primary agent process.

4. The method of claim 1, wherein the runtime class loading delegation mechanism includes maintaining a mapping of class name prefixes to corresponding class loaders for dynamic resolution during execution.

5. The method of claim 1, wherein the custom tracer transmits traces to a backend receiver dedicated to the custom agent extension without requiring reconfiguration of a collector of the primary agent process.

6. The method of claim 1, further comprising:
implementing a script as part of a build process to automate creating the custom compilation JAR.

7. The method of claim 1, wherein the runtime class loading delegation mechanism resolves conflicts between third-party library dependencies by isolating a given class loaders of the custom agent extension from the class loader of the primary agent process.

8. The method of claim 1, wherein the custom agent extension uses the shaded class names to create spans with attributes, timestamps, and identifiers unique to the custom tracer.

9. The method of claim 1, further comprising:
ensuring that the custom tracer is immune to modifications in global configuration settings of the primary agent process.

10. The method of claim 1, wherein the custom agent extension dynamically adapts to changes in architecture of the primary agent process, including modifications to class naming conventions or class loader hierarchies.

11. The method of claim 1, wherein the primary agent process comprises an open source software (OSS) Java Agent.

12. A tangible, non-transitory, computer-readable medium storing program instructions that cause a device to execute a process comprising:
obtaining a class loader of a primary agent process by identifying a parent loader of an extension loader in which a custom agent extension operates;
mapping shaded class names used by the primary agent process by inspecting a primary JAR file for classes required for the custom agent extension;
creating a custom compilation JAR by renaming classdata files of the primary JAR file to class files and repackaging the class files into the custom compilation JAR;
compiling the custom agent extension using the custom compilation JAR to reference the shaded class names;
implementing a runtime class loading delegation mechanism, wherein the custom agent extension dynamically resolves required classes from the class loader of the primary agent process; and
utilizing the shaded class names to create and register a custom tracer within the custom agent extension, wherein the custom tracer operates independently of the primary agent process and a primary tracer and exporter of the primary agent process.

13. The tangible, non-transitory, computer-readable medium of claim 12, wherein mapping the shaded class names comprises:
searching for class name prefixes matching a predetermined pattern associated with the primary agent process.

14. The tangible, non-transitory, computer-readable medium of claim 12, wherein the custom tracer transmits traces to a backend receiver dedicated to the custom agent extension without requiring reconfiguration of a collector of the primary agent process.

15. The tangible, non-transitory, computer-readable medium of claim 12, wherein the process further comprises:
implementing a script as part of a build process to automate creating the custom compilation JAR.

16. The tangible, non-transitory, computer-readable medium of claim 12, wherein the runtime class loading delegation mechanism resolves conflicts between third-party library dependencies by isolating a given class loaders of the custom agent extension from the class loader of the primary agent process.

17. The tangible, non-transitory, computer-readable medium of claim 12, wherein the custom agent extension uses the shaded class names to create spans with attributes, timestamps, and identifiers unique to the custom tracer.

18. The tangible, non-transitory, computer-readable medium of claim 12, wherein the primary agent process comprises an open source software (OSS) Java Agent.

19. An apparatus, comprising:
one or more network interfaces to communicate with a network;
a processor coupled to the one or more network interfaces and configured to execute one or more processes; and
a memory configured to store a process that is executable by the processor, the process comprising:
obtaining a class loader of a primary agent process by identifying a parent loader of an extension loader in which a custom agent extension operates;
mapping shaded class names used by the primary agent process by inspecting a primary JAR file for classes required for the custom agent extension;
creating a custom compilation JAR by renaming classdata files of the primary JAR file to class files and repackaging the class files into the custom compilation JAR;
compiling the custom agent extension using the custom compilation JAR to reference the shaded class names;
implementing a runtime class loading delegation mechanism, wherein the custom agent extension dynamically resolves required classes from the class loader of the primary agent process; and
utilizing the shaded class names to create and register a custom tracer within the custom agent extension, wherein the custom tracer operates independently of the primary agent process and a primary tracer and exporter of the primary agent process.

20. The apparatus of claim 19, wherein the primary agent process comprises an open source software (OSS) Java Agent.
